(19) United States
(12) Patent Application Publication
(10) Pub. No.: US 2005/0190051 A1
(43) Pub. Date: Sep. 1, 2005

(54) Vehicle brake warning system

(76) Inventor: Michael Walter Dinda, Madison Heights, MI (US)

Correspondence Address: ASHKAN NAJAFI, P.A., 6817 SOUTHPOINT PARKWAY, SUITE 2301, JACKSONVILLE, FL, 32216, US

(21) Appl. No.: 10/789,224

(22) Filed: Mar. 1, 2004

(51) Int. Cl. B60Q 1/50

(52) U.S. Cl. 340/467

(57) ABSTRACT

A brake warning system is attachable to a first vehicle and for warning a second vehicle of an anticipated first vehicle braking. The system includes a vacuum or electrical switch operably connected to the first vehicle engine vacuum system and further includes a mechanism for monitoring a vacuum pressure fluctuation thereof. The vacuum switch sends a plurality of signals corresponding to accelerating and non-accelerating modes of the first vehicle and has a flasher light switch operably connected to it for receiving the plurality of signals therefrom for indicating when an accelerator pedal is released. The light switch is operably connected to the first vehicle brake light and flashes during an interval defined after an accelerator pedal is released and before the brake pedal is engaged.

### CROSS REFERENCE TO RELATED APPLICATIONS

Not Applicable.

### STATEMENT REGARDING FEDERALLY SPONSORED RESEARCH OR DEVELOPMENT

Not Applicable.

### REFERENCE TO A MICROFICHE APPENDIX

Not Applicable.

### BACKGROUND OF THE INVENTION

1. Technical Field

This invention relates to a vehicle warning system and, more particularly, to a vehicle brake warning system for notifying a trailing vehicle of imminent braking.

2. Prior Art

The prevalence of rear end collisions has resulted in the installation of high mounted brake lights on all automobiles manufactured for sale in the United States after 1985. This has been done since it has been demonstrated that placement of brake lights in a trailing driver's field of view reduces the time between a leading vehicle brake light onset and the following vehicle's brake application by approximately 25%. This result is achieved by earlier perception that a braking action is taking place in the leading vehicle.

Avoidance of rear end collisions requires that a driver of a following vehicle maintain an appropriate intervening distance between that vehicle and the leading vehicle. When the leading vehicle executes a braking operation, maintenance of such appropriate intervening distance by the following vehicle requires that the driver thereof have time to perceive the braking condition, respond thereto and finally to decelerate. The mounting of a brake light directly in the field of view of the following driver enables earlier perception and, accordingly, where all things are otherwise equal, an earlier response and the onset of an earlier deceleration to maintain the requisite intervening distance.

Further, improvements in the following driver's ability to perceive a braking condition occurring in a leading vehicle are available if the activation apparatus for the brake light within the braking system of a vehicle provides a signal of anticipated stopping prior to an actual depression of a brake pedal thereby anticipating the operator actions. Thus, such telegraphing of an about to occur braking condition effectively removes the time interval between when the driver of a leading vehicle's foot is removed from the accelerator and actually impacts the braking pedal. While such an interval is typically measured in tenths of a second, the extension in the period of time for the driver of a following vehicle to perceive a braking condition and respond thereto provides a significant increase in safety. In some cases, the lead driver could be coasting for one or more full seconds before braking.

Accordingly, a continued need remains for a vehicle brake warning system to prevent a possible rear-end collision.

### BRIEF SUMMARY OF THE INVENTION

In view of the foregoing background, it is therefore an object of the present invention to provide a vehicle brake warning system for notifying a trailing vehicle of imminent braking. These and other objects, features, and advantages of the invention are provided by a brake warning system attachable to a first vehicle and for warning a second vehicle of an anticipated first vehicle braking. The first vehicle includes a battery, a brake light, a brake pedal for energizing the brake light when engaged, and a foot pressure operated accelerator pedal for accelerating the first vehicle.

The system includes a vacuum/electrical switch operably connected to the first vehicle's engine vacuum system for advantageously monitoring a vacuum pressure reduction during a process of the driver removing his foot from the accelerator. The vacuum/electrical switch is preferably disposed within a first vehicle engine compartment and the flasher-light switch may be disposed within a first vehicle trunk compartment. The vacuum/electrical switch generates and sends a plurality of signals corresponding to accelerating and non-accelerating modes of the first vehicle. The accelerating mode has a vacuum/electrical pressure level above a predetermined limit and the non-accelerating mode has a vacuum/electrical pressure level below the predetermined limit.

The flasher-light switch is operably connected to the vacuum/electrical switch for receiving the plurality of signals therefrom, and advantageously indicating when an accelerator pedal is released during operating conditions of a vehicle. The light switch is operably connected to the first vehicle's rear window or deck lid brake light and causes same to flash during an interval defined after an accelerator pedal is released and before a brake pedal is engaged or the accelerator pedal is depressed again. Advantageously, the flashing brake light can stay active during a coasting time interval. The present invention may further include an amber lens for replacing the first vehicle's rear window or deck lid brake light lens for providing additional visual notification of an impending slowdown to the second vehicle.

### BRIEF DESCRIPTION OF THE SEVERAL VIEWS OF THE DRAWING

The novel features believed to be characteristic of this invention are set forth with particularity in the appended claims. The invention itself, however, both as to its organization and method of operation, together with further objects and advantages thereof, may best be understood by reference to the following description taken in connection with the accompanying drawings in which:

FIG. 1 is a schematic block diagram showing the major elements of a vehicle brake warning system, in accordance with the present invention; and

FIG. 2 is a perspective view showing the vacuum/electrical switch, flashing light switch and the optional lens of the present invention.

### DETAILED DESCRIPTION OF THE INVENTION

The present invention will now be described more fully hereinafter with reference to the accompanying drawings, in which a preferred embodiment of the invention is shown. This invention may, however, be embodied in many different forms and should not be construed as limited to the embodiment set forth herein. Rather, this embodiment is provided so that this application will be thorough and complete, and will fully convey the true scope of the invention to those skilled in the art. Like numbers refer to like elements throughout the figures.

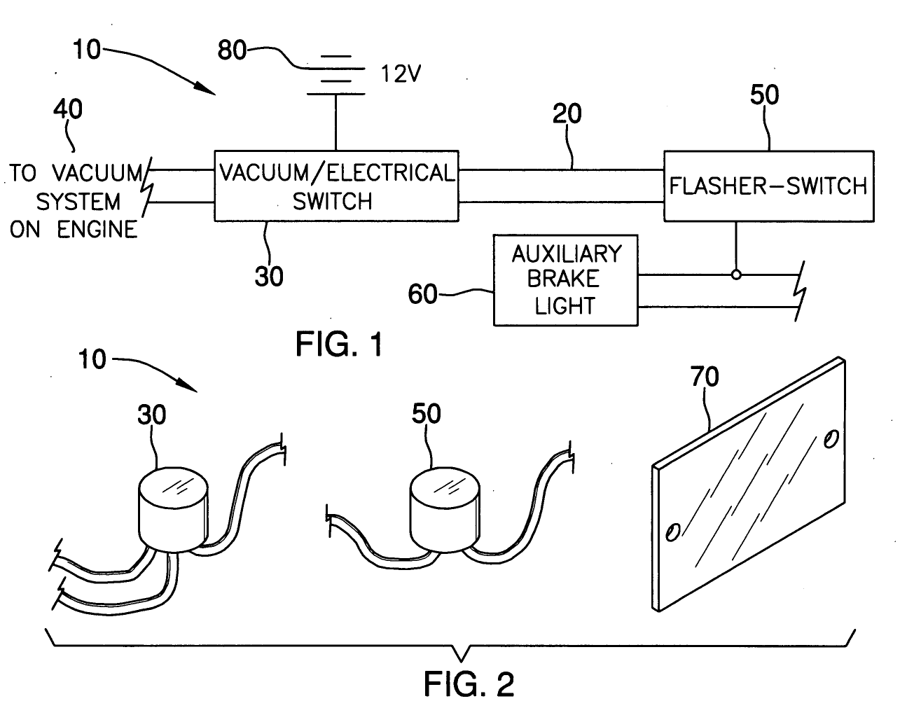

The system of this invention is referred to generally in FIGS. 1-2 by the reference numeral 10 and is intended to provide a vehicle brake warning system. It should be understood that the system 10 may be installed on many different land vehicles, and therefore should not be construed as having limited application to only conventional automobiles.

Referring initially to FIG. 1, the system 10 includes a brake warning system 20 attachable to a first vehicle and for warning a second vehicle of an anticipated first vehicle braking. The first vehicle includes a battery 80, a brake light 60, a brake pedal for energizing the brake light system when engaged, and a foot pressure operated accelerator pedal for accelerating the first vehicle.

The system 10 includes a vacuum/electrical switch 30 operably connected to the first vehicle engine vacuum system 40 and further includes a mechanism for advantageously monitoring a vacuum pressure fluctuation thereof during vehicle deceleration. The vacuum/electrical switch 30 is disposed within a first vehicle engine compartment and the flasher light switch 50 is disposed within a first vehicle trunk compartment. Of course, such elements may be positioned at alternate locations within the vehicle.

The vacuum/electrical switch 30 generates and sends a plurality of signals corresponding to accelerating and non-accelerating modes of the first vehicle. The accelerating mode has a vacuum/electrical pressure level above a predetermined limit and the non-accelerating mode has a vacuum/electrical pressure level below the predetermined limit.

The flasher light switch 50 is operably connected to the vacuum/electrical switch 30 and for receiving the plurality of signals therefrom, and advantageously indicating when an accelerator pedal is released during operating conditions of a vehicle. The flasher light switch 50 is operably connected to the first vehicle's rear window or deck lid brake light 60 and causes same to flash during an interval defined after an accelerator pedal is released and before the brake pedal is engaged. Advantageously, the flashing brake light 60 can stay active during an indefinite time interval, i.e., while the lead vehicle is coasting (accelerator released and brake pedal not engaged). Notably, the present invention further includes an optional amber lens 70 connected to the first vehicle rear window or deck lid brake light 60 for providing an optional visual notification of an impending slowdown to the second vehicle.

The appealing features of the system 10 are its automatic operation, convenience, and added safety. Instead of being warned of a deceleration only after a preceding motorist applies their brakes, a special red or optional amber caution light will flash when pressure is released from the accelerator. This allows the following motorist more response time to apply pressure to his or her own brakes. The system 10 also helps prevent rear-end collisions from occurring, thereby averting costly traffic violation fines, serious vehicular damage, higher insurance costs for all motorists involved, injuries and possible fatalities.

While the invention has been described with respect to a certain specific embodiment, it will be appreciated that many modifications and changes may be made by those skilled in the art without departing from the spirit of the invention. It is intended, therefore, by the appended claims to cover all such modifications and changes as fall within the true spirit and scope of the invention.

In particular, with respect to the above description, it is to be realized that the optimum dimensional relationships for the parts of the present invention may include variations in size, materials, shape, form, function and manner of operation. The assembly and use of the present invention are deemed readily apparent and obvious to one skilled in the art.

1. A brake warning system attachable to a first vehicle and for warning a second vehicle of an anticipated first vehicle braking, said first vehicle including a battery, a brake light, a brake pedal for energizing the brake light when engaged, and a foot pressure operated accelerator pedal for accelerating the first vehicle, said system comprising:
a switch operably connected to the first vehicle engine vacuum system and including means for monitoring a vacuum pressure fluctuation thereof during a predetermined time interval, said switch for generating and sending a plurality of signals corresponding to accelerating and non-accelerating modes of the first vehicle, said non-accelerating mode having a vacuum pressure level above a predetermined limit and said accelerating mode having a vacuum pressure level below the predetermined limit; and
a light switch operably connected to said switch and for receiving said plurality of signals therefrom for indicating when an accelerator pedal is released during operating conditions of a vehicle, said light switch being operably connected to the first vehicle brake light and for causing same to flash during an interval defined after an accelerator pedal is released and before the brake pedal is engaged.

2. The brake warning system of claim 1, wherein said switch comprises: a vacuum switch.

3. The brake warning system of claim 1, wherein said switch comprises: an electrical switch.

4. The brake warning system of claim 1, wherein said switch is disposed within a first vehicle engine compartment and said light switch is disposed within a first vehicle trunk compartment.

5. The brake warning system of claim 1, further comprising a lens connected to the first vehicle brake light and for providing additional visual notification of an impending slowdown to the second vehicle.

6. A brake warning system attachable to a first vehicle and for warning a second vehicle of an anticipated first vehicle braking, said first vehicle including a battery, a brake light, a brake pedal for energizing the brake light when engaged, and a foot pressure operated accelerator pedal for accelerating the first vehicle, said system comprising:
a switch operably connected to the first vehicle engine vacuum system and including means for monitoring a vacuum pressure fluctuation thereof during a predetermined time interval, said switch cooperating with said monitoring means for generating and sending a plurality of signals corresponding to accelerating and non-accelerating modes of the first vehicle, said non-accelerating mode having a vacuum pressure level above a predetermined limit and said accelerating mode having a vacuum pressure level below the predetermined limit; and
a light switch operably connected to said switch and for receiving said plurality of signals therefrom for indicating when an accelerator pedal is released during operating conditions of a vehicle, said light switch being operably connected to the first vehicle brake light and for causing same to flash during an interval defined after an accelerator pedal is released and before the brake pedal is engaged;
said switch being disposed within a first vehicle engine compartment and said light switch being disposed within a first vehicle trunk compartment.

7. The brake warning system of claim 4, further comprising a lens connected to the first vehicle brake light and for providing additional visual notification of an impending slowdown to the second vehicle.

8. A brake warning system attachable to a first vehicle and for warning a second vehicle of an anticipated first vehicle braking, said first vehicle including a battery, a brake light, a brake pedal for energizing the brake light when engaged, and a foot pressure operated accelerator pedal for accelerating the first vehicle, said system comprising:
a switch operably connected to the first vehicle engine vacuum system and including means for monitoring a vacuum pressure fluctuation thereof during a predetermined time interval, said switch cooperating with said monitoring means for generating and sending a plurality of signals corresponding to accelerating and non-accelerating modes of the first vehicle, said non-accelerating mode having a vacuum pressure level above a predetermined limit and said accelerating mode having a vacuum pressure level below the predetermined limit;
a light switch operably connected to said switch and for receiving said plurality of signals therefrom for indicating when an accelerator pedal is released during operating conditions of a vehicle, said light switch being operably connected to the first vehicle brake light and for causing same to flash during an interval defined after an accelerator pedal is released and before the brake pedal is engaged;
said switch being disposed within a first vehicle engine compartment and said light switch being disposed within a first vehicle trunk compartment; and
a lens connected to the first vehicle brake light and for providing additional visual notification of an impending slowdown to the second vehicle.
